(19) United States
(12) Patent Application Publication
(10) Pub. No.: US 2010/0092725 A1
(43) Pub. Date: Apr. 15, 2010

(54) Wallboard Tape And Method of Using Same

(76) Inventor: Lee Goldman, Millburn, NJ (US)

Correspondence Address: SILLS CUMMIS & GROSS P.C., ONE ROCKEFELLER PLAZA, IP DEPARTMENT - 25TH FLOOR, NEW YORK, NY, 10020, US

(21) Appl. No.: 12/576,381

(22) Filed: Oct. 9, 2009

Related U.S. Application Data
(63) Continuation-in-part of application No. 11/129,642, filed on May 16, 2005, now abandoned.

(51) Int. Cl. B32B 3/10; B32B 7/12

(52) U.S. Cl. 428/137; 428/350

(57) ABSTRACT

The present invention is a wallboard tape that simplifies the initial covering and installation of elongated wallboard joints formed by the abutting of adjacent wallboards. The wallboard tape includes a fibrous paper tape having a resin-impregnated body and a water-soluble, specially formulated water-activated adhesive layer applied to a surface of the body. The resin impregnated body remains relatively non-moisture absorbent during wetting of the adhesive layer thereby allowing the adhesive layer to dry several minutes after installation of the tape over a wall joint.

### CROSS REFERENCE TO RELATED APPLICATION

This application is a continuation-in-part of U.S. Application Ser. No. 11/129,642 filed May 16, 2005, hereby incorporated by reference.

### FIELD OF THE INVENTION

This disclosed technology relates generally to the construction and building trade, and more particularly to an improved version of paper-fiber wallboard tape. The wallboard tape of the present invention is used, e.g., to join gypsum drywall segments and to conceal the transition of the segments in a smooth seamless fashion from section to section.

### BACKGROUND OF THE INVENTION

The standard established procedure for joining wallboards is set in motion after securing wallboards to the building frame. Once secured, a layer of joint compound is applied (mud or plaster) to cover the space between drywall sections. Joint tape is then embedded within the compound running the length of the wallboard joint.

The generally accepted conventional tape calls for 85-95 pound Kraft paper with 0-2% wet strength properties. Specifications of paper used require set standards of high tensile fiber composition with wet, dry and cross tear strengths as the standard determined properties. The actual joint tape requirement for code compliant drywall assembly in commercial and residential construction is ASTM C-475. The specification guidelines are defined by the American Society for Testing and Materials also known as ASTM International. ASTM International develops voluntary consensus standards, related technical information, and services having internationally recognized quality and applicability that promote public health and safety, and the overall quality of life; contribute to the reliability of materials, products, systems and services; and facilitate national, regional, and international commerce.

Conventional drywall tapes are usually formulated from pulp becoming Kraft paper as the finished product. It is important to note that the above Kraft paper allows the penetration of the moist compound into the paper itself. These paper tapes may be produced with either a spark-perforated surface or a plain surface gypsum ribbon. Both paper types are typically slightly sanded creating a fine nap for greater adhesion qualities. These tapes may include a defined center margin for an accurate taping guide, particularly for corners. The considered benefits of spark-perforation are a faster and even drying outcome.

In either case the tape is applied in conjunction with a wet compound or plaster, requiring a great deal of skill to attach panels without wrinkles along the tape or bubbles from under the tape along the joint; the compound or plaster can contain pockets of air or trap existing air within the seam. Inside corner seams have their own degree of difficulty as the center crease is fit into the corner to provide equal-distant phalanges of paper on either angle. In both of these procedures there may be uneven compound to deal with or varying levels of drywall board to board joining.

Once the embedded tape is applied an important drying period is required. Depending upon the ambient atmosphere, the aeration time is approximately 18 to 24 hours. The drying is a critical factor so that the joint environment is free of moisture and the compound and tape have gone through the settling or shrinking process together. If moisture is present, it can breed mold and mildew that can spread throughout the wallboard perpetuating building decay and promoting a health hazard. This is equally true where the wallboard is of other than gypsum construction.

After the above steps are completed, a second coat of compound covers the tape, again needing to dry fully. Smooth sanding prepares for a possible third coat or in rare cases completes preparation for the final finishing, painting, etc. This established procedure requires two (possibly 3) time-consuming drying periods of 18-24 hours, regardless of the basic components (animal, starch, or polyvinyl acetate) found in the majority of compounds used.

In addition to the paper fiber tape, the art also employs fiberglass mesh tape as a joint seam. It is available in either a self-adhesive roll (one side adhesively coated) or a plain, non-adhesive staple roll, depending upon the user's preference. The believed benefit of this tape is twofold, an open grid fabrication that not only allows the compound to pass through to the seam, but also interlocks with the initial layer of compound. The general practice allows for the mesh as a first stage of application, and then follows the same procedures including a minimum two coats of compound that require extensive drying time as described above. The popular use for this fabrication is plastering rather than joining wallboard panels. One drawback using mesh fabrication is that it tends to fray and unravel in use; it also has an inability to maintain a fold, thereby making it nearly impossible to use in corners and off angles. Additionally, the mesh tape is more expensive than conventional paper tape, and is best suited for repairs than for wallboard joint connection.

There are other tapes used in the art that have self adhesive properties; paper with release liners and laminates. These tapes are expensive and despite their claim, are not user friendly; often tangling, adhering to itself, and/or are not compatible with general compounds. A disadvantage of the above tapes is that these tapes are not adjustable during application.

### SUMMARY OF THE INVENTION

The disclosed technology contemplates the provision of a fibrous or paper wallboard tape, which may be employed without the necessity of first applying an initial coat of compound or plaster to begin the wallboard assembly process. The merits of this are both economical and practical from the vantage point of the end user.

To this end, the inner surface of the tape with the general basic conventional product qualities is coated or layered with specially formulated, water soluble, water activated adhesive. The specially formulated water-activated adhesive layer may contain mold and mildew inhibitors. The tape is inert until wetted. Once activated by water, the tape adhesion to the adjacent joint follows. The specially formulated adhesive begins to bond the paper substrate to the gypsum panels by actually penetrating and integrating with the wallboard panel face paper as it aerates. This attachment is unlike any known compound-free bond in the trade, shrinks with the gypsum panel face paper as it dries. As settling occurs during and after installation the substrate reacts in unison with the panels it connects and does not allow for independent movement which can lead to cracks and consequent imperfections.

Drying is quick as the tape and specially formulated adhesive properties allow moisture to evaporate rapidly. Substantial wetting of the paper tape after it dries, as in the case of applying the bed coat of compound, is of little consequence to the bonding properties. The absence of the bedding coat allows moisture to evaporate quickly from the underlying joint. In less than approximately one hour after beginning the process, the final coat of either plaster or joint compound may be applied.

Specifically, the wallboard tape may include a fibrous paper tape, (e.g. a 70-100 lb. Kraft paper) and an eighteen to twenty pound coating of the specially formulated water-activated adhesive layer. The fibrous paper tape may have two planar surfaces and may be sized with a wet strength additive. The wet strength additive allows the planar surfaces of the fibrous paper tape to be nearly closed surfaces. The wet strength additive may be polyamidoamine-epichlorohydrin prepared in an alkaline system using kymene as an additive giving the wallboard tape a wet strength of 15-60%.

The nearly closed surfaces formed by the wet strength additive have two functions. The first is that the specially formulated water-activated adhesive layer may be applied to one of the planar surfaces in such a way that the specially formulated water-activated adhesive layer mostly sits on top of the first planar surface. And the second is to limit reactivation of the specially formulated adhesive layer during application of a finishing coat to the second planar surface. This configuration allows the fibrous paper tape to remain relatively non-moisture absorbent during wetting of the adhesive layer thereby allowing the wallboard tape to dry several minutes after installation of the wallboard tape to a desired target.

The wallboard tape may also include a mold and mildew inhibitor such as liquid polysiloxane. The mold and mildew inhibitor may be incorporated into the water-soluble, specially formulated water-activated adhesive layer by mixing in a proportion of less than five percent by volume. The wall board tape may also include air-conducting perforations that extend between the planar surfaces and/or a centerfold enabling the wallboard tape to be used with angle joints.

The wallboard tape may be elongated and packaged in roll form. The elongated wallboard tape may also have a width of approximately ⅛-6 inches and a length of approximately 20-600 feet and/or may be in the form of rectangles, squares, circles, and/or frames of rectangles, squares or circles.

In use, the wallboard tape may be used in conjunction with a wetted sponge or a vessel of water or a dispensing device.

### BRIEF DESCRIPTION OF THE DRAWINGS

FIG. 1 is a side view of the wallboard tape according to a first embodiment of the disclosed technology;

FIG. 2 is a bottom view of the wallboard tape according to a second embodiment of the disclosed technology;

FIG. 3 is a bottom view of the wallboard tape according to a third embodiment of the disclosed technology;

FIGS. 4a-b is a side view of the wallboard tape according to a fourth embodiment of the disclosed technology;

FIGS. 5a-b show the disclosed technology being used with a square electrical box; and

FIGS. 6a-b shows the disclosed technology being used with a circular electrical box.

### DETAILED DESCRIPTION OF THE DISCLOSED EMBODIMENT

In accordance with the invention, the disclosed embodiment may include many forms, although the majority of use is in the form of an elongated resin impregnated tape. Other such forms may be rectangles, squares, circles, and frames of those shapes, as well as appliqués combined with other materials for use as adjuncts or as accessories in activities associated with the construction industry and general crafts where applicable. For example, the tape may be configured in designs in order to frame holes for ceiling lamps, recessed lighting, and cutouts in wallboard or join adjacent wallboards for electrical sockets. In addition, the tape may be used for sealing holes made for electrical conduit, HVAC or plumbing pipes penetrating wallboard construction in order to supply multiple services

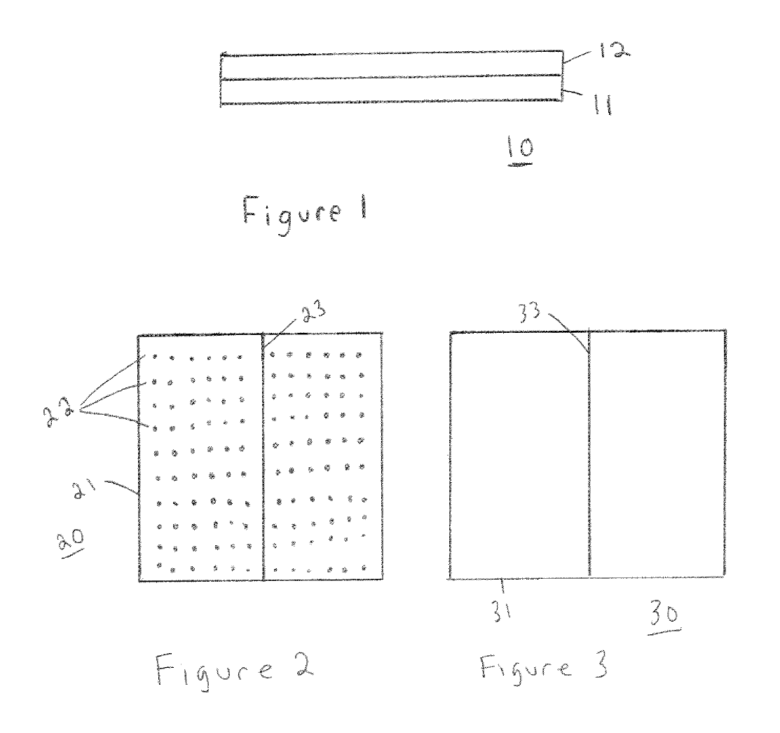

As shown in FIG. 1, the first embodiment 10 of the present invention comprises of a first layer of fibrous material 11 and a water-activated adhesive layer 12 applied to one surface thereof.

The first layer of fibrous material may be a 70-100 lb. Kraft paper (natural or bleached) that may be treated with heavy sizing for wet strength. Sizing or size is a substance that is applied to materials as a protecting glaze, filler, or lubricant. It is used to change surface properties in papermaking, gilding, and the manufacture of textiles and fiberglass. Sizing can be used on cellosic fibers during paper manufacture in order to curb their tendency to absorb liquids by capillary action. Sizing affects abrasiveness, creasibility, finish, printability, smoothness, and surface bond strength and decreases surface porosity and fuzzing.

There are two types of sizing: internal sizing and surface sizing. Internal sizing is applied to almost all papers and especially to all those that are machine made, while surface sizing is added for the highest grade bond, ledger, and writing papers.

Surface sizing solutions consists of mainly modified starches or sometime other hydrocolloid as gelatine and a surface sizing agent such as AKD or acrylic co-polymers. Surface sizing agents are amphipathic molecules, having both hydrophilic (water-loving) and hydrophobic (water-repelling) ends. The sizing agent covers the cellulose and forms a film, with the hydrophilic tail facing the fiber and the hydrophobic tail facing outwards. This creates a water-repellent situation. Surface sizing improves the surface strength, printability and water resistances of the paper surface.

Internal sizing chemicals are used in papermaking at the wet end of processing. Internal sizing solutions may include ASA, AKD and rosin. Internal sizing agents influence dewatering, retention of fillers and fibers in the paper sheet, may increase water resistance and interlocks the fibers of the paper tape. These substances also may make the paper web more hydrophobic and may increase the papers wet strength.

Wet strength is the ability of paper products to maintain a substantial proportion of its original strength after being completely saturated with an aqueous solution. Wet strength is most evident and significant when it occurs in absorbent papers and should not be confused with water repellency or the resistance of paper to wetting when exposed to water. Normally, a paper loses most of its strength when saturated with water, and one which retains more than 15% of its dry strength when completely saturated with water may correctly be referred to as a “wet-strength paper.” A very superior wet-strength paper may retain as much as 60% of its dry strength when wet.

In the preferred embodiment, the Kraft paper fiber may be treated with an internal sizing agent for wet strength. The desired wet strength is 15-60% of the papers dry strength. The most common additives for wet strength are Urea-Formaldehyde or Melamine-Formaldehyde. These additives permit moisture absorbency and are formulated in an acid system. These additives are very strong and low cost but they always contain traces of free formaldehyde. During development, it was discovered that employing formaldehyde for wet strength in any form, created a cross linking between the paper tape and the adhesive, rendering the resultant product both inconsistent and ineffective for purposes associated with the disclosed technology. Therefore, an alternative additive was needed for the disclosed technology.

To overcome this problem, it was found that polyamidoamine-epichlorohydrin prepared in neutral or alkaline systems was more effective and was better suited for the wet strength properties needed for the disclosed technology. For example, it is necessary for the paper tape to reflect wet strength control, specifically, having near dry strength properties when wet to resist tearing. Also, this sizing makes for rapid drainage properties which in turn results in shortening drying time. Further, the alkaline system formulation with the additive kymene is a preferred pairing for the water-activated, starch based adhesive of the disclosed technology.

After formation of the wet-strength paper, the wet-strength paper tape will have two sides. The first is a felt side and the second is a wire side. Both the felt side and the wire side will be nearly or fully closed to limit absorption. The felt and wire sides were closed during the papermaking process using the wet strength additives.

The advantages of having the wire side closed are two-fold. First, you can limit the possibility of adhesive reaction during the drying process (i.e., once dry, moisture from the finishing layer of joint compound will not be able to penetrate or awaken the adhesive) and, second, it heightens drying times. If the wire side was to absorb significant amounts of water it would increase drying time therefore defeating the products purpose. But, on the other hand, if the wire side was completely water resistant or water repellent it would fight the next process in drywall installation when the joint tape is covered with a finishing coat.

The adhesive may be a water-activated gum that may be starch-based and/or water-soluble. In a preferred embodiment, the adhesive may be a dextrin or corn starch adhesive, a polyvinyl acetate or a standard gummed adhesive, such as is used on envelopes or packing tape but any other suitable adhesive which is capable of bonding tape to the sheets of material which are to be bundled together may also be used.

The adhesive may be applied on the felt side of the Kraft paper during a secondary process. The adhesive mostly sits on top of the felt side of paper because the felt side is nearly closed and only a small amount of the adhesive is absorbed into the felt side of the paper. This property allows the activated adhesive to wick quickly. Another benefit of the adhesive sitting on top of the paper is that more adhesive may be applied to the paper and since there is more adhesive to bond and integrate with its target (e.g., the wallboard face), the adhesive will emulsify easier. Another major benefit of the tape application is that, there is an adjustability time frame. This time frame is created after the application of the tape to its target surface. During the first few minutes after application, the tape can be moved so that trapped air or wrinkles can be eliminated before the wet adhesive emulsifies thereby covering the joint with precision.

The secondary process of applying the adhesive to the paper involves slowly sending the resin-impregnated paper tape through a conveyer-like system for the adhesive integration. Specifically, the felt side of the tape is exposed to adhesive penetration, e.g., spraying the adhesive on the paper. The adhesive may have a coating weight of 15-25 lbs, but the preferred weight is 18-20 lbs.

The paper, now with the adhesive, is then sent through a drying process such as sending the adhesive-covered paper through an oven at approximately 250-450 degrees F. Additionally, the paper may go through two rewind processes where it may be cure-broken. The cure-broken process is to alleviate twisting or curling when the paper tape is wetted, ready for application to the wallboard panel seam. Once complete, the paper tape is prepared for the production into a finished product.

The tape 10 may be conveniently packaged in roll form as known in the art. The tape 10 may be in a variety of widths, mostly ranging between one-eighth inch and six inches, and lengths from 20 feet to 600 feet, most commonly approximately 2 inches by 300 feet, which will be normally adequate to cover the gaps formed by abutting wallboards, and more specifically, about 2 1/16 inches by 250 feet.

As shown in FIG. 2, extending between the outer surface and the inner surface of the fibrous layer 21 may or may not have air-conducting perforations 22 covering substantially the entire area of the tape 20 at intervals of one-eighth inch, which may be either punched or spark-perforated.

As is known in the art and shown in FIG. 3, a preferred centerfold 33 may be employed to enable the tape 30 to be used with angle joints, as well as joints formed by inside corners of a wall. This centerfold 33, known in the art as a center margin, serves as a rule guide for the user.

The specially formulated adhesive layer 12 is preferably roll-coated using known techniques to conventional thickness. And since the wet-strength or resin-impregnated paper is mechanically stronger than untreated Kraft paper, the fibrous material 11 may be of a lesser thickness than the conventional product.

In use, the tape 10 may be employed either by moistening the adhesive layer 12 using a wetted sponge (not shown), immersing the tape roll in a vessel of water, spraying the wall and/or the tape with a spray bottle or a dispensing device that may or may not incorporate a wetted sponge. It is possible to wet the exposed surface of the wallboard adjacent to the joint so that moisture transfer from the wallboard wets the adhesive surface 12 of the tape 10 when applied.

Water activates the specially formulated adhesive which expands into the wallboard face paper. During this emulsifying stage, the specially formulated adhesive in the felt side of the paper tape merges with the fibers of the wallboard face paper. The adhesive and paper tape is then dry in less than an hour (drying time may take longer in high humidity conditions). The wetting is facilitated by the fact that the paper layer 11 which is sized via resin impregnating does not absorb and retain substantial amounts of moisture, which also facilitates subsequent drying of the adhesive. As a result, the tape 10 is sufficiently dried and ready for the application of a finish coat of plaster/compound after several minutes, specifically, after 30 minutes to an hour or in less than one hour.

Preferably, during application, a sponge brushing of the applied tape length across the joint takes place after application to ensure proper bonding wetness and a smooth drying result. During this period, the tape 10 may be accurately positioned if not originally properly aligned without difficulty.

An important feature to be noted is that within the specially formulated adhesive formula there may be provided mold and mildew inhibitors for preventing bacterial growth. While a variety of such agents are commercially available, a preferred composition is sold under the trademark “Sil-75”, a liquid polysiloxane available from the Dow Chemical Corporation of Midland, Mich. This composition is preferably incorporated into the adhesive by mixing in a proportion of less than five percent by volume. The preferred and most effective embodiment, however, is in a range of one to two percent by volume.

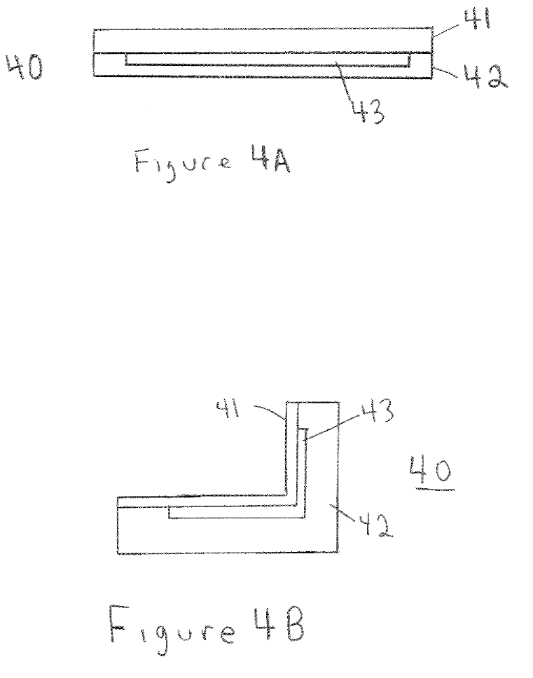

In an additional embodiment shown in FIGS. 4a-b, the wallboard tape 40 having paper 41 and adhesive 42 may be incorporated with a stiffening member 43 such as a metal or plastic strip. The strip may come in a flat section as shown in FIG. 4a or a cornered section as shown in FIG. 4b. This stiffening member 43 may strengthen the wallboard tape and/or a joint at a desired target. And when used on corners and edges, the stiffening member 43 may make the angles at the edges and corners sharper as well as more resistant to wear and tear.

FIGS. 5a-b show the wallboard tape being used with an opening for an electrical outlet. FIG. 5a shows a typical household electrical box 50 surrounded by a typical rough cutout 51 cut to fit the perimeter of the electrical box 50. As shown in FIG. 5a, the rough cut 51 may have jagged edges and in some cases may be larger than a standard outlet cover. FIG. 5b shows an embodiment where the wallboard tape 52 provides a defined edge 53 to compensate for the jagged or misshaped edge of the cutout 51. This wallboard tape 52 may be adhered over the electrical box cover via the wallboard tape 54. The wallboard tape 52 may also have a stiffening member 55 in the shape of an electrical outlet cover surrounded by the wallboard tape.

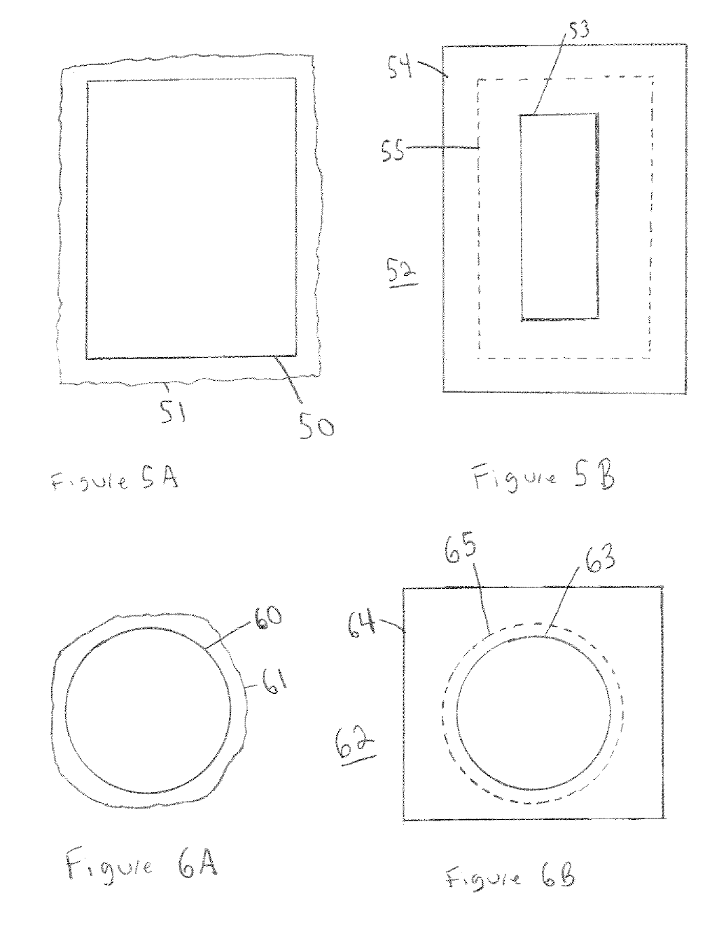

FIGS. 6a-b show the wallboard tape being used with an opening for a circular lamp outlet. FIG. 6a shows a typical circular household electrical box 60 surrounded by a typical rough cutout 61 cut to fit the perimeter of the electrical box 60. As shown in FIG. 6a, the rough cut 61 may have jagged edges and in some cases may be larger than wall cover of a lamp. FIG. 6b shows an embodiment where the wallboard tape 62 provides a defined edge 63 to compensate for the jagged or misshaped circumference of the cutout 61. This wallboard tape 62 may be adhered over the lamp box cover via the wallboard tape 64. The wallboard tape 62 may also have a stiffening member 65 in the shape of a circle that surrounds the wallboard tape.

Additionally, it will be observed that since the adhesive layer is not activated prior to actual application to the joint, should any longitudinal twisting occur as the strip is handled, it can be readily straightened as the strip is applied without danger of the adhering layer adhering to itself, as is the case where pressure sensitive adhesives are employed. To achieve this non twisting attribute, during the coating curing process an added step was taken to break the coating trend to curl. This method is referred to as “cure-broken” has eliminated the tendency to waver during application. This can be seen on the coated side by the naked eye as a cross-hatch pattern on the bias within the adhesive coating.

Of equal importance is the fact that the cost of manufacture of the disclosed tape is only marginally greater than that of conventional paper tape, and well within the price range of the highest quality fiberglass tape.

With the elimination of the initial layer of compound, fewer person-hours are necessary to accomplish the drywall joint task and a great savings emerges. The improved tape may be used in connection with wallboards of other than gypsum type with equal facilities.

Another major benefit of the tape application is that unlike self adhesive tapes, there is an adjustability time frame while applying that eliminates trapped air or wrinkles as the wet adhesive emulsifies and slides easily covering the joint with precision.

The present invention is not limited to the precise details of structure described in the specification, for obvious modifications will occur to those skilled in the art to which the invention pertains. And although the present invention has been described in detail and with particularity, it will be appreciated by those skilled in this art that changes and modifications can be made therein without departing from the scope and spirit of the invention.

1. A wallboard tape comprising:
a fibrous paper tape, the fibrous paper tape having a first planar surface and a second planar surface, the fibrous paper tape being sized with a wet strength additive, the wet strength additive allowing the first planar surface and the second planar surface to be nearly closed surfaces; and
a water-activated adhesive layer, the water-activated adhesive layer being applied to the first planar surface in such a way that the water-activated adhesive layer mostly sits on top of the first planar surface,
wherein the fibrous paper tape remains relatively non-moisture absorbent during wetting of the adhesive layer thereby allowing the wallboard tape to dry several minutes after installation of the wallboard tape to a desired target.

2. The wallboard tape of claim 1 wherein the nearly closed surface of the second planar surface limits reactivation of the adhesive layer during application of a finishing coat to the second planar surface.

3. The wallboard tape of claim 1 wherein the wet strength additive is polyamidoamine-epichlorohydrin.

4. The wallboard tape of claim 3 wherein the polyamidoamine-epichlorohydrin is prepared in an alkaline system.

5. The wallboard tape of claim 4 wherein the alkaline system uses kymene as an additive.

6. The wallboard tape of claim 1 wherein the fibrous paper tape is a 70-100 lb. Kraft paper.

7. The wallboard tape of claim 1 wherein the fibrous paper tape has a wet strength of 15-60%.

8. The wallboard tape of claim 1 wherein the wallboard tape is elongated.

9. The wallboard tape of claim 8 wherein the elongated wallboard tape is packaged in roll form.

10. The wallboard tape of claim 8 wherein the elongated wallboard tape has a width of approximately ⅛-6 inches and a length of approximately 20-600 feet.

11. The wallboard tape of claim 1 wherein the wallboard tape is one of a rectangle, a square, a circle, and/or frames of rectangles, squares or circles.

12. The wallboard tape of claim 1 wherein the wallboard tape is used in conjunction with a wetted sponge.

13. The wallboard tape of claim 1 wherein the wallboard tape is used in conjunction with a vessel of water.

14. The wallboard tape of claim 1 wherein the wallboard tape is used in conjunction with a dispensing device.

15. The wallboard tape of claim 1 further comprising:
a mold and mildew inhibitor.

16. The wallboard tape of claim 15 wherein the mold and mildew inhibitor is a liquid polysiloxane.

17. The wallboard tape of claim 15 wherein the mold and mildew inhibitor is incorporated into the water-activated adhesive layer by mixing in a proportion of less than five percent by volume.

18. The wallboard tape of claim 1 further comprising:
air-conducting perforations that extend between the first planar surface and the second planar surface.

19. The wallboard tape of claim 1 further comprising:
a centerfold, the centerfold enabling the wallboard tape to be used with angle joints.

20. The wallboard tape of claim 1 further comprising:
a stiffening member incorporated within the wallboard tape, the stiffening member strengthening the wallboard tape at the desired target.
